(19) United States
(12) Patent Application Publication
(10) Pub. No.: US 2026/0301025 A1
(43) Pub. Date: Oct. 1, 2026

(54) BICYCLE MOBILITY SUBSIDIZED BY LIVE DIGITAL ADVERTISING SYSTEM

(71) Applicant: Hector German, Jr., New York, NY (US)

(72) Inventor: Hector German, Jr., New York, NY (US)

(21) Appl. No.: 19/699,572

(22) Filed: Jun. 5, 2026

Related U.S. Application Data
(63) Continuation of application No. 17/964,495, filed on Oct. 12, 2022.
(60) Provisional application No. 63/263,903, filed on Nov. 11, 2021.
(60) Provisional application No. 63/264,108, filed on Nov. 16, 2021.
(60) Provisional application No. 63/329,922, filed on Apr. 12, 2022.

(51) Int. Cl. G06Q 30/0251; G07C 9/00

(52) U.S. Cl. CPC G06Q 30/0266; G07C 9/00896

(57) ABSTRACT

A bicycle-based mobile display transportation system includes a central computer control system. An application interface allows a bicycle user to register with the transportation system. The system includes bicycle dock stations having displays and being equipped with dock station computer control systems, and one or more bicycles equipped with two or more bicycle displays. said two or more bicycle displays being placed significantly parallel to one or more of wheels of the bicycle; and wherein each of said one or more bicycles is equipped with a bicycle computer control system. Images shown by the bicycle displays and dock station displays are based on location parameters. An application interface hosted by the central computer control system provides an advertising user with an ability to register and upload both advertising content and advertisement display rules. The bicycle dock stations include bike dock locks for securing the bicycles.

### CROSS-REFERENCE TO RELATED APPLICATIONS

This application is a continuation of and claims the benefit of U.S. non-provisional patent application Ser. No. 17/964,495 filed on Oct. 12, 2022, which claims the benefit of U.S. Provisional patent applications Ser. No. 63/263,903 titled “Bicycle Mobility Live Digital Advertising System”, filed on Nov. 11, 2021, and Ser. No. 63/264,108 titled “Bicycle Mobility Live Digital Advertising System”, filed on Nov. 16, 2021, and Ser. No. 63/329,922 “Bicycle Mobility Subsidized by Live Digital Advertising System”, filed on Apr. 12, 2022, the disclosures of each of which are herein incorporated by reference in their entireties.

### PATENTS CITED

The following documents and references are incorporated by reference in their entirety, Yu (U.S. Pat. Pub. No. 2019/0095959), Courter (U.S. Pat. No. 8,857,084), Trainer (U.S. Pat. Pub. No. 2010/0237645), Balscheit (U.S. Pat. No. 7,617,626), Zeliang (CN 107481061), Yushen (CN106875232) and Liles et al (U.S. Pat. No. D374,848).

### FIELD OF THE INVENTION

The invention relates to a mobility advertising system and specifically to a shared ride system implemented through bicycles or similar human operated devices whose costs are subsidized by associated live digital advertising.

### DESCRIPTION OF THE RELATED ART

Both environmental and mobility convenience have seen more and more cities explore the convenience and value of micro-mobility solutions, such as one-way rental of scooters and bicycles. The ability to use any of these (typically one-way), then drop them off somewhere else, provide users with a convenient, one-way, mobility solution to get from a mass transit location to their destination and vice-versa, or from home to a store.

As with all things, getting these solutions to have wide acceptance involves expenses, which are usually leveled at the tax structure or borne by the users through use fees. In some cases, the complete setup is ‘branded’ (e.g. Citi Bikes in NYC), but that only goes so far, requiring the payment by users of the equipment.

What is needed, is a way to alleviate or eliminate these expenses, particularly with a system based on bicycles, through the unique ability of micro-mobility solutions to move among people.

### SUMMARY OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’is used in relation to one or more steps in a method or process.

In one aspect, the invention is about a bicycle-based mobile display transportation system comprising: a central computer control system equipped with at least one processor, at least one memory module, at least one database and internet communication components, so that an application interface hosted on said computer control system allows a bicycle user to register with the transportation system to separate a bicycle for use, one or more bicycle dock stations, each said bike dock station equipped with a dock station control system equipped with at least one processor, at least one memory module, at least one database and internet communication components capable of connecting to said central computer control system as well as to each said bicycle on each said bike dock lock as well as to one or more dock stations displays, one or more bicycles, each said bicycle equipped with two or more displays, said displays placed significantly parallel to one or more of said bicycles wheel's, wherein each said bicycle is equipped with a bicycle computer control system equipped with at least one processor, at least one memory module, at least one database, and bicycle location awareness components, so that the images shown on said one or more displays are based on one or more of said bicycle's location parameters, an application interface hosted by said central computer control system that provides an advertising user the ability to register and upload both the advertising content of one or more advertisements as well as the rules of when said advertising is to be displayed on one or more of said bicycle's displays according to specific advertisement display rules; and wherein said bike dock locks are capable of charging the batteries on said bicycles and interconnecting with said bicycles computer components.

In another aspect said advertisement display rules include one or more of the following: synchronized system time, bicycle geographic location parameter or specific advertisement play instructions, said bicycle geographic location parameters include one or more of the following: synchronized system time, bicycle geographic coordinates, bicycle location within a defined advertising district or bicycle distance to a specific advertisement target. In yet another aspect said advertising district is defined through one or more of the following: an area defined within specific geographic coordinates, an area defined within specific streets or avenues or an area within a specific distance of a central feature. In another aspect said bicycles are commanded to display the same advertising at a given time. In yet another aspect said bicycles are commanded to display the same while within a specific advertising district. In another aspect said bicycles are commanded to display the same advertising while within a specific distance to a specific location.

In one aspect the invention is about a bicycle-based mobile display transportation method comprising: providing a central computer control system equipped with at least one processor, at least one memory module, at least one database and internet communication components, so that an application interface hosted on said computer control system allows a bicycle user to register with the transportation system to separate a bicycle for use, providing one or more bicycle dock stations, each said bike dock station equipped with a dock station control system equipped with at least one processor, at least one memory module, at least one database and internet communication components capable of connecting to said central computer control system as well as to each said bicycle on each said bike dock lock as well as to one or more dock stations displays, providing one or more bicycles, each said bicycle equipped with two or more displays, said displays placed significantly parallel to one or more of said bicycles wheel's, wherein each said bicycle is equipped with a bicycle computer control system equipped with at least one processor, at least one memory module, at least one database, and bicycle location awareness components, so that the images shown on said one or more displays are based on one or more of said bicycle's location parameters, providing an application interface hosted by said central computer control system that provides an advertising user the ability to register and upload both the advertising content of one or more advertisements as well as the rules of when said advertising is to be displayed on one or more of said bicycle's displays according to specific advertisement display rules and wherein said bike dock locks are capable of charging the batteries on said bicycles and interconnecting with said bicycles computer components.

In one aspect, the invention is about a non-transitory computer-readable medium embodying a program executable by at least one computing device, the program when executed causing said at least one computing device to implement a method for a bicycle-based mobile display transportation method comprising providing a central computer control system equipped with at least one processor, at least one memory module, at least one database and internet communication components, so that an application interface hosted on said computer control system allows a bicycle user to register with the transportation system to separate a bicycle for use, providing one or more bicycle dock stations, each said bike dock station equipped with a dock station control system equipped with at least one processor, at least one memory module, at least one database and internet communication components capable of connecting to said central computer control system as well as to each said bicycle on each said bike dock lock as well as to one or more dock stations displays, providing one or more bicycles, each said bicycle equipped with two or more displays, said displays placed significantly parallel to one or more of said bicycles wheel's, wherein each said bicycle is equipped with a bicycle computer control system equipped with at least one processor, at least one memory module, at least one database, and bicycle location awareness components, so that the images shown on said one or more displays are based on one or more of said bicycle's location parameters, providing an application interface hosted by said central computer control system that provides an advertising user the ability to register and upload both the advertising content of one or more advertisements as well as the rules of when said advertising is to be displayed on one or more of said bicycle's displays according to specific advertisement display rules and wherein said bike dock locks are capable of charging the batteries on said bicycles and interconnecting with said bicycles computer components.

Other features and advantages of the present invention will become apparent upon examining the following detailed description of an embodiment thereof, taken in conjunction with the attached drawings, which are provided for purposes of illustration and not of limitation.

### BRIEF DESCRIPTION OF THE DRAWINGS

FIG. 1 shows a front perspective of an empty bicycle base station, according to an exemplary embodiment of the invention.

FIG. 2 shows a front-perspective of a full bicycle base station, according to an exemplary embodiment of the invention.

FIG. 3 shows a closer perspective of the empty bicycle base station positions, according to an exemplary embodiment of the invention.

FIG. 4 shows a closer perspective the occupied bicycle base station positions, according to an exemplary embodiment of the invention.

FIG. 5 shows an architecture topology of the various system components, according to an exemplary embodiment of the invention.

FIG. 6-9 show various perspectives of a two display bicycle, according to exemplary embodiments of the invention.

FIG. 10-12 show various perspectives of a four display bicycle, according to exemplary embodiments of the invention.

FIG. 13 shows a side view of a two-display bicycle, according to an exemplary embodiment of the invention.

The above-described and other features will be appreciated and understood by those skilled in the art from the following detailed description and drawings.

### DETAILED DESCRIPTION OF THE INVENTION

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

The present invention refers to a Bicycle Mobility Subsidized by Live Digital Advertising System (BMMSLDAS). In it, dynamic digital advertising offered as a service to advertisers through dynamic displays on both mobile vehicles (in one embodiment principally bicycles 202) and the bike dock 100 (comprised of a smart bicycling store/recharging station), allows for the revenue obtained from the advertising users subsidizing the cost of operating a fleet of both bicycles and charging/storage locations 100 as well as of the computer servers associated with the system operation.

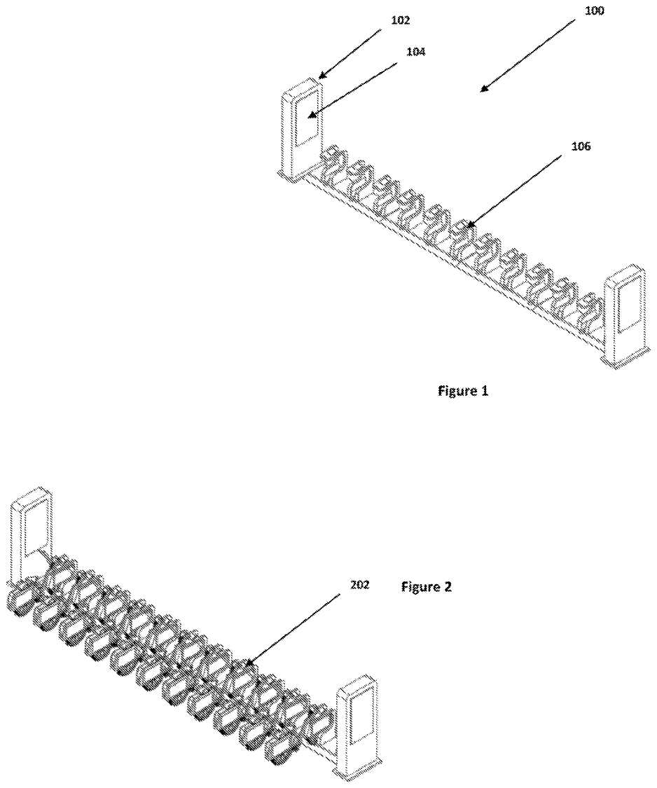

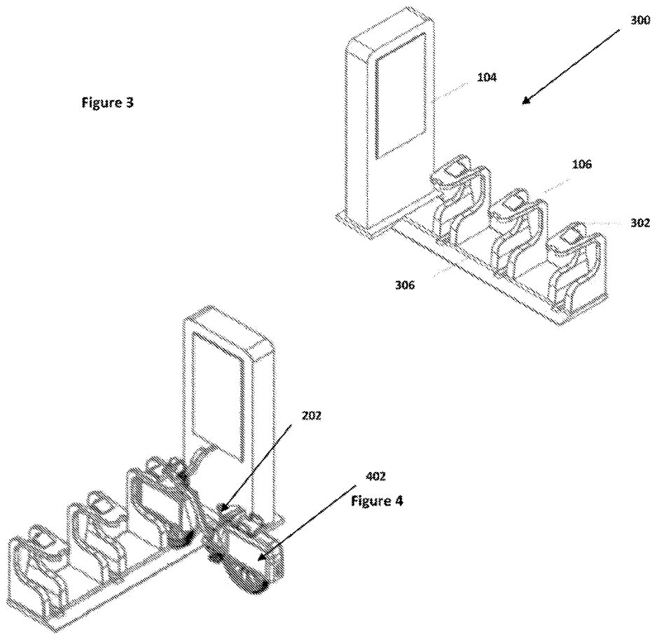

As seen in FIG. 1-5 the principal base component is a bicycle 202 (either completely human powered or with assistive electric components) that is equipped with one or more dynamic displays 402 which may be driven/dynamically addressable either individually or as pairs/groups at various times/locations, so that targeted advertising may be displayed through these displays 104/402.

There are effectively three separate types of computer systems at play in the overall system 500. A central computer control system 502 controls the associated app and website for scheduling/selling/reporting of advertisements for advertising users 504 of the system 500. A bicycle dock station 100 computer control system interacts with the advertising bicycles 202, dock station displays 104 and other infrastructure. Each said bicycle 202 has an on-board bicycle content computer control system 506 for the displays and other bicycle functions. All three computer control systems 502/504/506 content management systems are all interlinked by the internet 506. Again, we note that the advertisements or ads used may be static or video displays including all or portions of audio.

In one embodiment, the bicycle 202 is comprised of one to four smart monitors or displays 402 on one or both ends/sides of the bicycle 202. These displays 402 show both digital still images and videos from an on-board computer control/storage/display components 508 integrated into the frame of the bicycle. In this fashion these digital images or video may be static or dynamic, so as to change every certain predefined time and/or based on the location of the bicycle through advertisement display rules. The bicycle location is determined to generate the bicycle geographic locations (as either coordinates or map location) by the bicycle location awareness components, which derive the location information through location systems including GPS/BDS/Galileo/Glonass satellite navigation systems, triangulation off cell phone antennas, navigation off RFID tags/beacons, etc. In those cases, as the bicycle moves from base station to base station, or as a function of location, speed, beacons or other parameter, the advertisements change.

To use the system, a bicycle user registers with the system, and provides some form of financial guarantee (CCard/Venmo/Zelle), to be used in case of damage/loss of the bicycle. Using the system app on their smart device (or the interface at the bicycle dock station), the user separates a bicycle 202 and travels freely around the area. If the user leaves the allowed ride area (based on the bicycle location parameters (generated by the bicycle location electronics), a message is sent both to the rider's phone and/or to the displays on the bicycle. When the user is done with the bike, it may opt to return it to a system dock station, provide it to another rider (and transfer the status) or even abandon it and notify the system during an emergency (a charge may be incurred).

As the bicycle transits, the advertisements are displayed in any particular order (both static and videos). Cued as a function of the location/time. An advertising user may program the display of a particular ad on ALL bicycles at a particular time (across a city, or nationwide). Or when the bicycle 202 is within a particular distance of a store (e.g. displaying a CVS add while in front of the Walgreen's), or in a particular location (in front of the Walgreen's as opposed to next to it). Similarly, an advertising user may define an ‘advertising district’ (either a geographic coordinate box, or the space between W 43rd & 39th between 6th and 7th avenue (i.e. Times Square) within which all system bicycles will display the same add on specific date/time.

In one embodiment, the location of the bicycle may be used to drive the displays 402 towards safety enhancements for the rider. In one example, the displays 402 may be made brighter and/or to flash as the bicycle approaches an intersection, goes through one or is awaiting a light to change (with the goal of increasing the bicycle visibility to other vehicles and/or pedestrians). Similarly, if a rider is following system directions (as part of an enhancement), the bicycle may flash the displays on the right or left side as it approaches the turning point, providing a sort of highly visible ‘turn signal’.

In one embodiment, the bicycles may have internet connectivity 512, as well as rain/weather/time of day/twilight/sunrise awareness, so that the ads may be programmed targeted to these changing environmental situations. Again, similar awareness may occur from connectivity to the smart bicycle base station via a local connection (say local Wi-Fi 510 of the dock 100 or even wired connection through the dock lock 106). Note that in yet another embodiment, the wireless connectivity 512 of the bike may be via a Bluetooth or similar connection to the user's phone, which then provides the wireless internet connectivity (e.g., 4G/5G or similar).

In one embodiment, the bike dock station 100 is comprised of a Totem or tower 102 with one or more displays 104 (which may be touchscreen), one or more bike dock locks 106, a bike status display 302 and a base 306 to secure both the bike lock 106 as well as any utility/internet ducts/interconnects through which the dock stations 100 may be connected to utilities.

In one embodiment 100, there may be a totem 102 with one or more displays 104 displaying dynamic information, bike information and software related to the unlocking of the bikes from the station, as well as connection to the charging mechanism(s). The base stations may have grid or off-grid electrical power (using wind, solar or other energy), as well as internet connectivity.

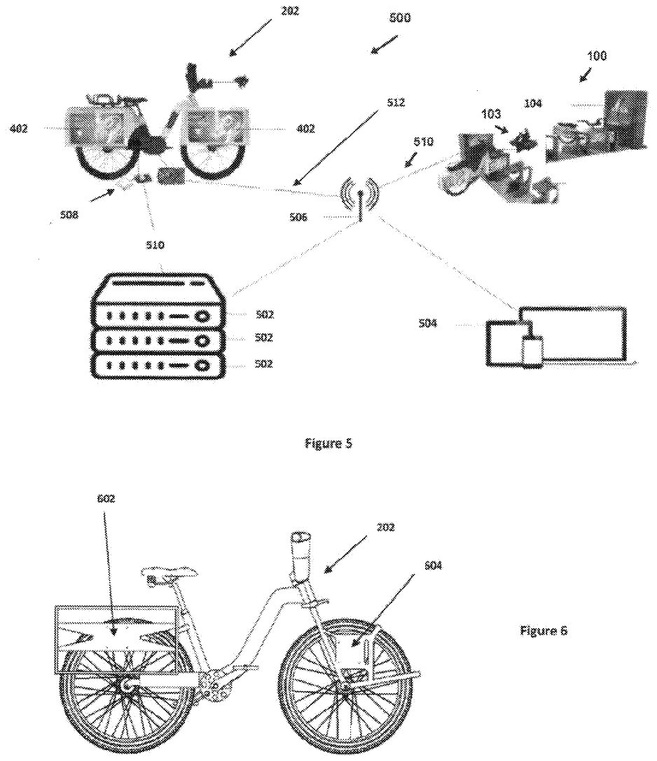

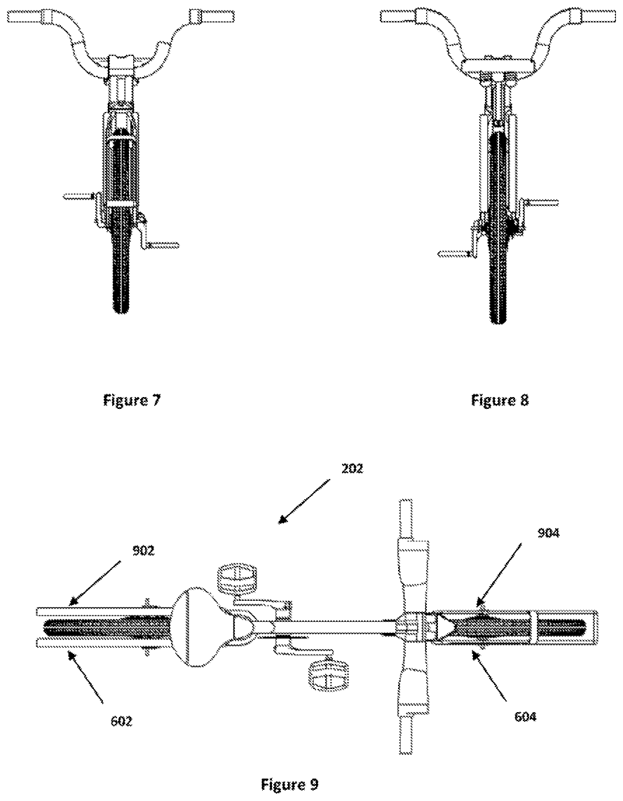

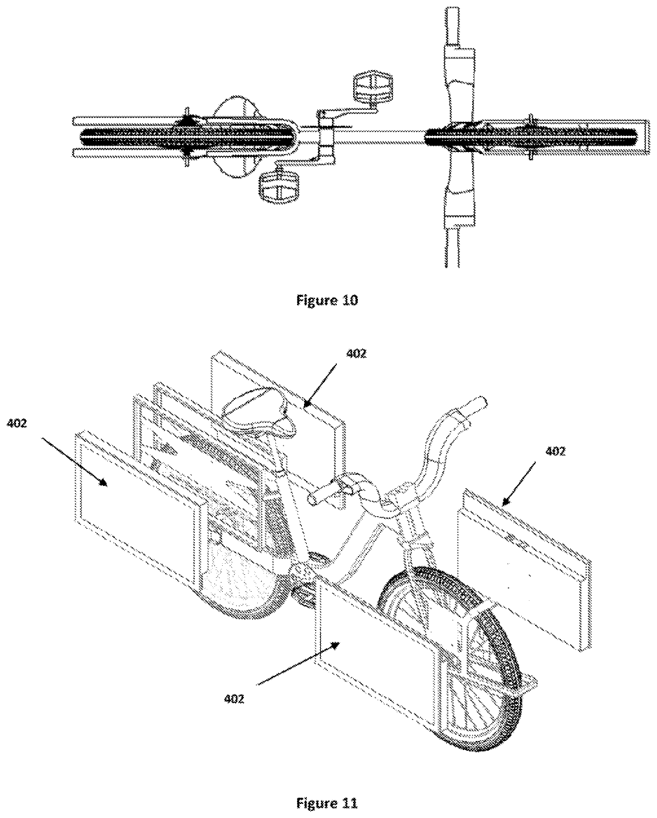

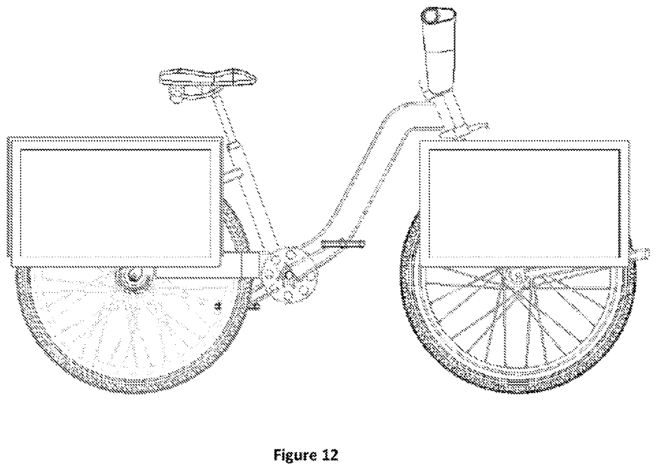

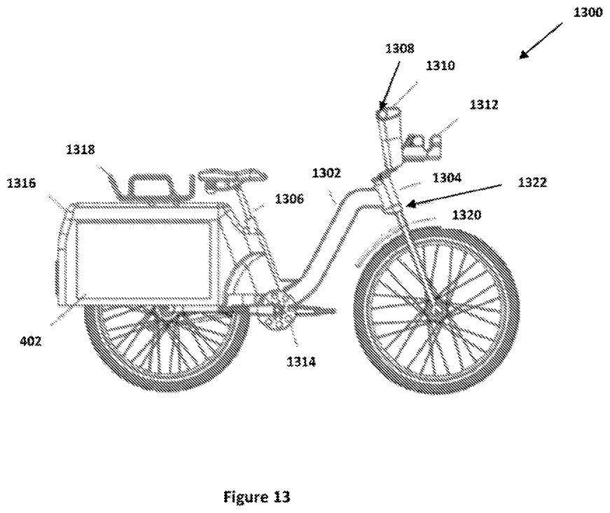

The proposed displays 402 may be mounted (FIG. 6-12) on various parts of the bicycle 202, including on one or both sides of the rear 602/902, and/or one or both sides of the front 604/904. The displays 402 may be all the same or slightly modified. Similarly, they may be driven together or separately by the content management system 502, or via the off-board system 502 through the wireless 512.

In another embodiment, a dual display bicycle 1300 may be used. With two displays 402 in the back, the bicycle may also be comprised of a frame 1302, a front fork 1304, Seat tube system 1306, handle bar 1308, handle bar cover 1310, front basket 1312, mechanical traction system 1314, rear monitor case 1316, rear basket 1318, bike fender 1320 and charging lock device 1322.

In one embodiment, each bicycle may have purely manual locomotion, whereas in another they may have total or partial electrical motion assistance. Exemplary embodiment parts and components may be seen in the attached drawings. We also note that since the energy in the bicycle may be itself generated by the users (through either generative service (as a portion of their pedaling effort) or re-generative braking (as they go downhill and regulate their speed), part of this energy may be used to generate the advertising display energy!

The above allows for a number of options. In one, users providing ‘net energy gains’ (say via more pedaling and less use of the bike's batteries) may obtain ‘credits’ to future rentals. Similarly, a bike may suggest a route to the user (based on their intended destination) so that a larger/different/targeted group see the ads (say passing in front of a sports event and/or a hospital), then direct said user via ‘street directions’, in exchange for credits and/or coupons.

The smart station with one or more digital live displays having internet connectivity form part of the BMMSLDAS. In one embodiment, in addition to the system bikes 202, the smart universal lock and charging dock 100 may be used not only by the system “smart bicycles” 202 with one or more displays 402 but for any privately owned bicycle. The smart station will allow any conventional or electronically assistance bicycle to dock “lock and charge” either through an inductive flexible charger and/or cables. Similar in operation to an electric car charger, registered bicycle users may place their privately owned bicycle within the dock station 100, lock it using their private locks and/or the dock station's locks 106 and leave it safe to recharge. Such a service may be free, a direct charge to an account/credit card, or use a credit that the user has from having either generated ‘net energy’ while riding a system bike 202 and/or driven a specific advertising route (as discussed above).

### EXAMPLE

The example implementation below should be useful in understanding the overall context of the system, although it is not a limiting embodiment in any fashion:

Once the Bicycle is docked to the smart bicycle station (via physical connectors and/or wirelessly through Wi-Fi, Bluetooth and/or Wireless cellular connectivity (e.g. 4G or 5G or similar), the bicycle computer components will get updates and new advertisement products, as well as charge to their motion components (again, either wired or wirelessly).

An embedded system responsible for downloading pre-processed media made available by the Content Management System in the cloud, saving and displaying ads on the bicycle's display panels (e.g. LED panels) allows the bicycle to display advertisement in case the internet connectivity of the bicycle is not present or not working.

Computer and GPS system with internet connectivity integrated into the frame of the bicycle allow live digital images or video to change every certain predefined time as the bicycle moves constantly by different location and parameters and update at the same time automatically via internet connectivity. Note that the advertisement may also change while charging, effectively converting a base station into a mini-mall of ads!

### CONCLUSION

In concluding the detailed description, it should be noted that it would be obvious to those skilled in the art that many variations and modifications can be made to the shown embodiments without substantially departing from the principles of the present invention. Also, such variations and modifications are intended to be included herein within the scope of the present invention as set forth in the disclosure.

It should be emphasized that the above-described embodiments of the present invention, particularly any “exemplary embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention.

What is claimed is:

1. A bicycle-based mobile display transportation system comprising:
a central computer control system equipped with at least one processor, at least one memory module, at least one database, and internet communication components so that an application interface hosted on said central computer control system allows a bicycle user to register with the transportation system;
one or more bicycle dock stations, each of said one or more bicycle dock stations having one or more dock station displays and being equipped with a dock station computer control system equipped with at least one processor, at least one memory module, at least one database, and internet communication components capable of connecting to said central computer control system as well as to each bicycle and to said one or more dock station displays;
one or more bicycles, each of said one or more bicycles being equipped with two or more bicycle displays, said two or more bicycle displays being placed substantially parallel to one or more of wheels of the bicycle; and wherein each of said one or more bicycles is equipped with a bicycle computer control system, said bicycle computer control system being equipped with at least one processor, at least one memory module, at least one database, and bicycle location awareness components so that images shown on one or more of said two or more bicycle displays and/or said one or more dock station displays are based on one or more bicycle location parameters generated by said bicycle location awareness components;
an application interface hosted by said central computer control system that provides an advertising user with an ability to register and upload both advertising content of one or more advertisements as well as advertisement display rules for when an advertisement is to be displayed on one or more of said two or more bicycle displays and/or said one or more dock station displays according to said advertisement display rules; and
each of said one or more bicycle dock stations including one or more bike dock locks on said one or more bicycle dock stations for securing said one or more bicycles to said one or more bicycle dock stations wherein said one or more bike dock locks are capable of charging batteries on said one or more bicycles and interconnecting with said bicycle computer control system as well as said central computer control system to allow a bicycle to be separated from said one or more bike dock locks for use.

2. The bicycle-based mobile display transportation system of claim 1, wherein said two or more bicycle displays continue to display and dynamically change advertisements while said bicycle is docked at and being charged by one of said one or more bicycle dock stations.

3. The bicycle-based mobile display transportation system of claim 1, wherein said two or more bicycle displays are dynamically addressable individually or as groups, such that different advertisements are simultaneously displayed on different ones of said two or more bicycle displays on a same bicycle.

4. The bicycle-based mobile display transportation system of claim 1, wherein said bicycle computer control system of each of said one or more bicycles further comprises a local storage module, and wherein said bicycle computer control system downloads and stores pre-processed advertising content from said central computer control system while said bicycle is docked at one of said one or more bicycle dock stations, said bicycle computer control system being configured to display said pre-processed advertising content on at least one of said two or more bicycle displays when internet connectivity of said bicycle computer control system is unavailable.

5. The bicycle-based mobile display transportation system of claim 1, wherein said central computer control system is configured to allow a first bicycle user to transfer a rental status of a bicycle to a second bicycle user without returning said bicycle to one of said one or more bicycle dock stations, and wherein said central computer control system updates said at least one database to associate said bicycle with said second bicycle user upon said transfer.

6. The bicycle-based mobile display transportation system of claim 1, wherein each of said one or more bicycles is configured to generate energy through one or more of pedaling effort by said bicycle user and regenerative braking, and wherein said central computer control system is configured to provide credits toward future rentals based on net energy gains generated by said bicycle user while operating said bicycle.

7. The bicycle-based mobile display transportation system of claim 1, wherein said one or more bike dock locks are configured to secure and charge not only said one or more bicycles of the transportation system but also privately owned bicycles, said one or more bicycle dock stations allowing any registered bicycle user to dock, lock, and charge a privately owned bicycle at said one or more bicycle dock stations.

8. The bicycle-based mobile display transportation system of claim 1, wherein said central computer control system is configured to provide credits redeemable for docking and charging services at said one or more bicycle dock stations in exchange for said bicycle user following a specific advertising route designated by said central computer control system.

9. The bicycle-based mobile display transportation system of claim 1, wherein at least one of said two or more bicycle displays is mounted on one or both sides of a front of the bicycle in a fixed position parallel to a front wheel of the bicycle.

10. The bicycle-based mobile display transportation system of claim 1, wherein said central computer control system suggests a route to said bicycle user based on their intended destination so that an increased number of advertisement viewers see advertisements displayed on said bicycle displays, and directs said bicycle user via street directions in exchange for credits.

11. The bicycle-based mobile display transportation system of claim 1, wherein said one or more bicycles have internet connectivity and weather awareness, and wherein advertisements displayed on said two or more bicycle displays are programmed and targeted based on changing environmental situations including one or more of rain, weather, time-of-day, twilight, and sunrise.

12. The bicycle-based mobile display transportation system of claim 1, wherein said central computer control system is configured to allow said bicycle user to abandon a bicycle during an emergency and notify said central computer control system of said abandonment, wherein a charge is assessed to said bicycle user upon said abandonment.

13. The bicycle-based mobile display transportation system of claim 1, wherein internet connectivity of said bicycle computer control system is provided via a short-range wireless connection to a phone of said bicycle user, said phone providing wireless internet connectivity to said bicycle computer control system.

14. The bicycle-based mobile display transportation system of claim 1, wherein said two or more bicycle displays are mounted on one or both sides of a rear of the bicycle and on one or both sides of a front of the bicycle.

15. The bicycle-based mobile display transportation system of claim 1 wherein said advertisement display rules include one or more of: synchronized system time, bicycle geographic location parameters or specific advertisement play instructions; said bicycle geographic location parameters include one or more of: synchronized system time, bicycle geographic coordinates, bicycle location within a defined advertising district, or bicycle distance to a specific advertisement target.

16. The bicycle-based mobile display transportation system of claim 15 wherein said advertising district is defined through one or more of: an area defined within specific geographic coordinates, an area defined within specific streets or avenues, or an area within a specific distance of a central feature.

17. The bicycle-based mobile display transportation system of claim 16 wherein said one or more bicycles are commanded to display a same advertisement while within a specific advertising district.

18. The bicycle-based mobile display transportation system of claim 16 wherein said one or more bicycles are commanded to display a same advertisement while within a specific distance to a specific location.

19. A bicycle-based mobile display transportation system comprising:
a central computer control system equipped with at least one processor, at least one memory module, at least one database, and internet communication components so that an application interface hosted on said central computer control system allows a bicycle user to register with the transportation system;
one or more bicycle dock stations, each of said one or more bicycle dock stations having one or more dock station displays and being equipped with a dock station computer control system equipped with at least one processor, at least one memory module, at least one database, and internet communication components capable of connecting to said central computer control system as well as to each bicycle and to said one or more dock station displays;
one or more bicycles, each of said one or more bicycles being equipped with two or more bicycle displays, said two or more bicycle displays being placed substantially parallel to one or more of wheels of the bicycle; and wherein each of said one or more bicycles is equipped with a bicycle computer control system, said bicycle computer control system being equipped with at least one processor, at least one memory module, at least one database, and bicycle location awareness components so that images shown on one or more of said two or more bicycle displays and/or said one or more dock station displays are based on one or more bicycle location parameters generated by said bicycle location awareness components;
an application interface hosted by said central computer control system that provides an advertising user with an ability to register and upload both advertising content of one or more advertisements as well as advertisement display rules for when an advertisement is to be displayed on one or more of said two or more bicycle displays and/or said one or more dock station displays according to said advertisement display rules; and
each of said one or more bicycle dock stations including one or more bike dock locks on said one or more bicycle dock stations for securing said one or more bicycles to said one or more bicycle dock stations wherein said one or more bike dock locks are capable of charging batteries on said one or more bicycles and interconnecting with said bicycle computer control system as well as said central computer control system to allow a bicycle to be separated from said one or more bike dock locks for use;
wherein said two or more bicycle displays are made brighter and flash as said bicycle approaches an intersection, and wherein said bicycle flashes said displays on a right or left side as said bicycle approaches a turning point to provide a turn signal.
